(19) United States
(12) Patent Application Publication
(10) Pub. No.: US 2003/0024768 A1
(43) Pub. Date: Feb. 6, 2003

(54) Adhesively bonded oil pan assembly

(76) Inventor: Bart R. Jones, Midland, MI (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/921,636

(22) Filed: Aug. 3, 2001

(51) Int. Cl. F16C 3/14

(52) U.S. Cl. 184/1.5

(57) ABSTRACT

There is disclosed an oil pan assembly (10) including an oil pan (12) having a first mating surface (14) and an engine component (16) having a second mating surface (18). The engine component (16) is adhesively bonded to the oil pan (12) with an adhesive (22).

### TECHINCAL FIELD

The present invention relates to adhesively bonded engine component assemblies and more particularly to adhesively bonded oil pan assemblies. The invention also relates to oil pan assemblies employing a cure-on-demand adhesive.

### BACKGROUND OF THE INVENTION

Historically, fabrication techniques for the manufacture of automotive engine oil pan assemblies have involved the fabrication of one or more metal components to form the oil pan followed by the joining of the oil pan to the engine block or another component using fasteners, with an intermediate disposed gasket. These techniques tend to be costly, require several parts and be labor intensive.

In particular, the formation of metal oil pans can be extremely costly due to the materials, tools and labor required to shape or mold the pans. Additional expense and labor may be required to form (e.g., machine or otherwise form) openings in a peripheral edge of the oil pan and in the engine block to receive several fasteners for joining the pan and the block. Moreover, the attachment of expensive heavy metal oil pans can be cumbersome and may require painstaking labor to attach the fasteners to the engine block and the oil pan.

Accordingly, there is a need to provide a method of manufacture and resulting assembly, pursuant to which oil pans or oil pan assemblies are joined to an engine block or other component with an adhesive bond. There is a further need for the respective components to be attached to each other in the optional absence of fasteners, a gasket or both. There is still a further need for a high integrity adhesive joint be achieved between an oil pan and an engine block wherein the oil pan is made from a material that is less cumbersome and easier to process than metal such as a polymer or plastic.

### SUMMARY OF THE INVENTION

The present invention meets the above needs and others by providing an automotive engine oil pan assembly including an engine block having a first mating surface, and an oil pan having a second mating surface. A layer of adhesive is provided between the oil pan and the engine block in contact with the respective mating surfaces for joining the oil pan and engine block to define an oil pan assembly.

### BRIEF DESCRIPTION OF THE DRAWINGS

FIG. 1 is an exploded perspective view of an oil pan assembly in accordance with the present invention.

FIG. 2 is a sectional view of joints formed for the oil pan assembly of FIG. 1 in accordance with the present invention.

FIG. 3 is an exploded perspective view of an alternative oil pan assembly in accordance with the present invention.

FIG. 4 is a sectional view of a joint formed for the alternative oil pan assembly of FIG. 3 in accordance with the present invention.

### DETAILED DESCRIPTION OF THE PREFERRED EMBODIMENT

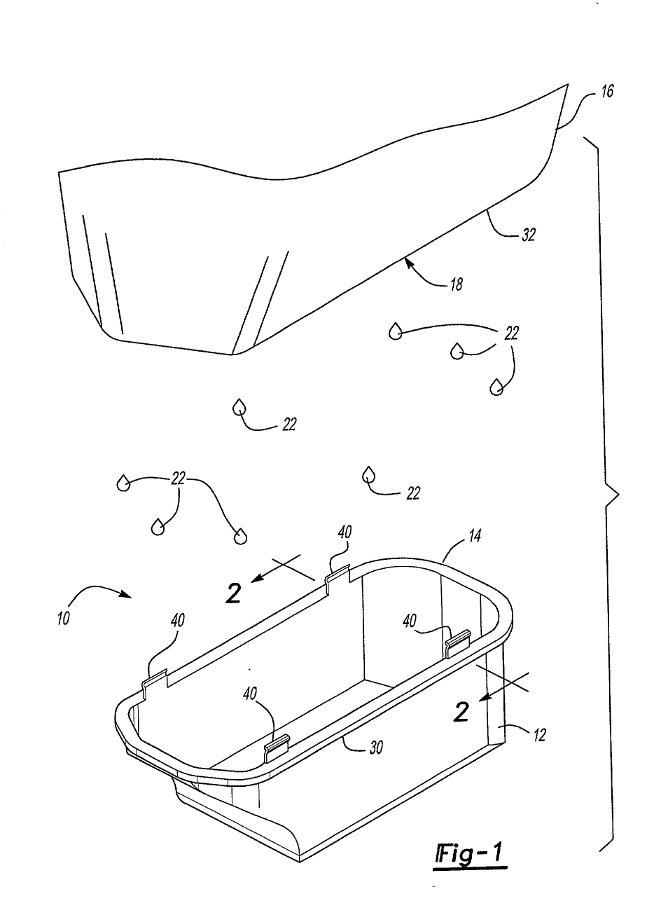

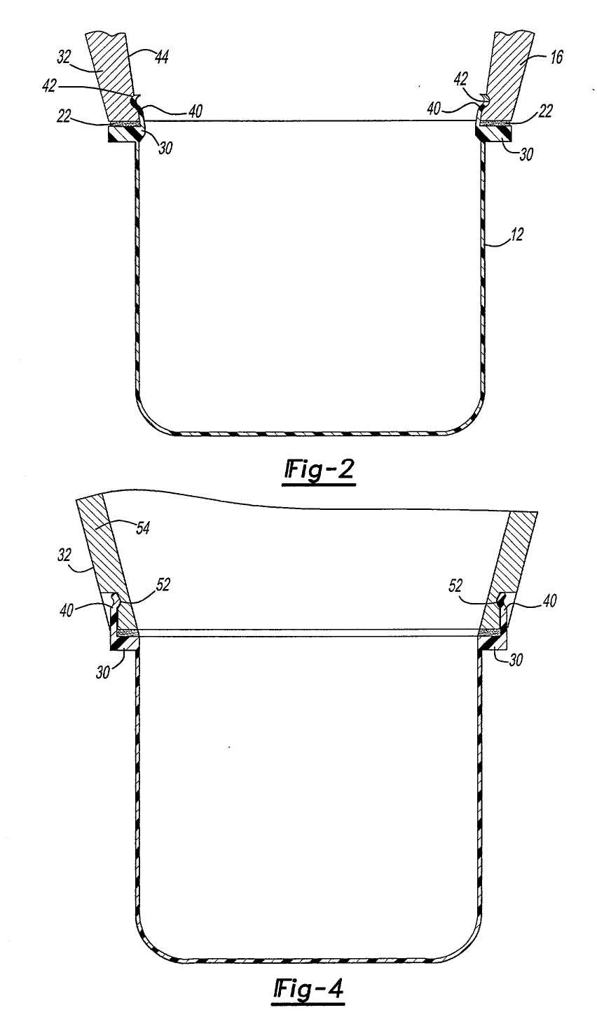

Referring to FIGS. 1 and 2 there is shown an oil pan assembly 10 of the present invention including an oil pan 12 having a first mating surface 14. The assembly 10 also includes an engine component 16 (e.g., a cast engine block) having a second mating surface 18. The oil pan 12 is bonded to the engine block 16 with a first intermediate layer of adhesive 22. Either or both of the first or second mating surfaces can include one or more additional coatings, layers or components. Thus, it is contemplated that the mating surfaces of any of the components may not necessarily be integrally formed on the components.

Optionally, either or both of the oil pan 12 or the engine component 16 has a structure for facilitating joinder, location or both of the components 12, 16 relative to each other. In FIGS. 1 and 2 (where like parts are denoted by like reference numerals), there is shown one example of an oil pan assembly 10 according to the present invention. Typically, a first mating structure 30 (e.g., a peripheral lip) associated with one component (e.g., the oil pan 12) will engage a corresponding second mating structure 32 (e.g., a peripheral edge or other suitable surface of the cast engine block 16). Such engagement can be about the periphery of a component, on an interior portion (not shown) or both.

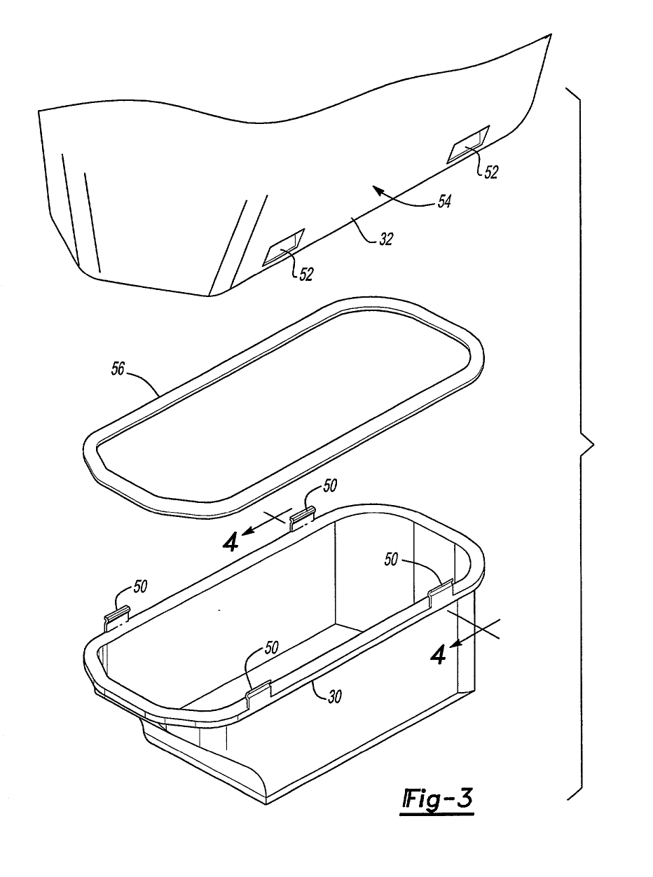

As desired, any suitable coating mating structures may be employed to assist in joining or locating the components relative to each other for forming joints. For instance, a friction fit, an interference fit or some other interlock fit may be used. Examples of suitable joints include butt joints, lap joints, tongue in groove joints or the like. In the exemplary embodiment of FIGS. 1 and 2, a plurality of snapping clips 40 penetrate through holes of the engine component 16 and are spaced about an inner portion of the first structure 30 for engaging grooves 42 formed in an internal wall 44 of the second structure 32. In another exemplary embodiment in FIGS. 3 and 4, a second set of clips 50 is relocated to be spaced about an outer portion of the first structure 30 for engaging cut outs 52 that are formed on an outer wall 54 of the second structure 32. Further examples of suitable structures and joints are illustrated in commonly owned, co-pending U.S. patent application Ser. No. 09/826,477 (filed Apr. 4, 2001; entitled “Adhesively Bonded Engine Intake Manifold Assembly”) and U.S. patent application Ser. No. 09/825,721 (filed Apr. 4, 2001; entitled “Adhesively Bonded Radiator Assembly”). Other suitable structures or surface treatments may be employed for providing an increase in the amount of surface area of the mating surfaces of the joint, or the overlap between the respect mating surfaces of the components. Further, as will be appreciated from FIGS. 1-4, optionally, a tang or other like structure may be formed (e.g., on mating structure 30) for assisting in achieving a snap fit or for providing an audible locator for facilitating assembly. It should also be appreciated that the above structures may be suitably interchanged between components. For example, a lip portion may be provided on a cast engine block and an abutting end may be provided on an oil pan.

The adhesive is preferably provided over at least a portion of the surfaces to be joined, and preferably sufficiently about the periphery so that there are no appreciable gaps that result between joined components. In one embodiment, a bead of adhesive is placed (e.g., by pumping) on the respective mating surface of at least one of the components and the opposing mating surface is brought into contact with it. The assembly is then cured. In another embodiment, the adhesive is precoated (e.g., by spraying, dipping, brushing, swabbing, or the like) on one or both of the mating surfaces of the respective components and then the components are joined and cured. Any other suitable joining technique may likewise be employed. Preferably the amount of adhesive employed is sufficient to achieve the desired performance characteristics of the assembly. Such amount will vary from application to application.

In one embodiment, as illustrated in FIG. 3 by layer 56, the invention encompasses having disposed on the mating surfaces of the respective components a continuous bead or film of adhesive. As used herein continuous bead or film of adhesive means a bead or film of adhesive that is disposed around the periphery of the mating surface and the end of the adhesive bead or film connects with the beginning of the adhesive bead or film. The continuous bead or film of adhesive upon cure is capable all of forming an air and liquid tight seal between the components. This function allows the adhesive bead or film to replace gaskets as the sealing means. The adhesive may be applied to the oil pan assembly components in the immediate vicinity of the location where the components are to be contacted with each other or it may be applied in a location remote from where or when the components are to be contacted. Remote as used herein refers can refer to one or both of time and location. In the embodiment where the adhesive is applied to one or more of the components remote from the place wherein the components are joined together a cure-on-demand adhesive is used.

In a preferred embodiment of the present invention, the oil pan is fabricated from a plastic material, i.e., a thermoset material, a thermoplastic material, or a mixture thereof. Among preferred high-performance thermoplastic materials are polybutylene terephthalate, polyetherimides, polyphenylene ether/polyamide resins, polyether sulfone resins, polyether ether ketone resins, liquid crystal polymers, polyarylsulfone resins, polyamideimide resins, polyphthalimide resins, nylon 6,6, polyamide resins, syndiotactic polystyrene, and blends thereof. In a particular preferred embodiment, the material is a thermoplastic selected from polyamides, polystyrenes, polyolefins, polycarbonates, or mixtures thereof. More preferably, the material is selected from polyamides (e.g., nylon 6,6), polystyrenes or mixtures thereof. In one preferred embodiment, the material is a blend of polyamides and syndiotactic polystyrenes, and more preferably a blend of nylon 6,6 and syndiotactic polystyrene. Among useful thermoset materials are epoxy resins.

The plastics used for preparing the components typically will also include other ingredients, such as reinforcements, property modifiers (e.g., impact modifiers, flame retardants, UV protectants or the like) or other suitable fillers (e.g., chopped glass, mineral, talc, calcium carbonate, or the like). For instance, in one embodiment, the plastic is glass filled in an amount of about 10 to about 50 volume percent and more preferably about 35 volume percent. Preferably, the material selected exhibits a tensile strength of at least about 175 MPa and more preferably at least about 225 MPa, and an elongation of about 1 to about 10%, and more preferably about 3 to about 5%. The material is also thermal resistant and will withstand without degradation temperatures of at least about 135° C. (about 275° F.) and more preferably 177° C. (350° F.) for at least about 144 hours and more preferably 168 hours.

Of course, one or more of the components (e.g., the engine block) might be a metal (e.g., cast iron, steel, magnesium, aluminum, titanium or the like), a composite, a ceramic (e.g., a carbide, a nitride, a boronitride, or the like), or some other material. The plastic components of the assembly are preferably injection molded using conventional techniques and processing conditions. Alternatively, they may be prepared in another suitable manner, such as by compression molding, thermoforming, blow molding or the like.

Either or both of the component materials or the adhesive may be suitably treated (uniformly or locally) as desired to improve corrosion resistance, oxidation resistance, thermal resistance, or another characteristic of the final product. For instance, they might be admixed, impregnated or coated with suitable additives for achieving a desired property. In some instances, bond strengths might be enhanced by further contacting the adhesive with a suitable primer.

The adhesive of the present invention is a structural adhesive and more preferably is a curable on demand material. Any adhesive that after cure can withstand the conditions of use of an engine (e.g., for an automotive vehicle) can be used. Preferably such adhesive does not decompose or delaminate at temperatures of up to about 138° C. (280 □ F.), more preferably up to about 143° C. (290 □ F.), even more preferably up to about 160° C. (320 □ F.) and most preferably up to about 191° C. (375 □ F.).

Furthermore, the adhesive is able to withstand exposure to hydrocarbon materials, calcium chloride, brake fluid, glycol coolants, windshield washer solvents and the like, at the above-mentioned temperatures and the pressures to which the internal combustion engine reaches internally. In an optional embodiment, the adhesive is able to bond to other engine components, which may be metallic, ceramic, composite, plastic, or the like. The adhesive used may be curable via a variety of known mechanisms including heat cure, infrared cure, ultraviolet cure, chemical cure, radio frequency cure, solvent loss and moisture cure.

In another embodiment the adhesive is a cure-on-demand adhesive which requires a separate operation to cause the adhesive to begin to cure. In one embodiment this is achieved by using an encapsulated curing agent which is ruptured during assembly. In another embodiment this is achieved by removing a protective coating to expose the adhesive to ambient conditions. Cure can be initiated by exposing the adhesive to heat, infrared or ultraviolet light sources, or to shearing forces and the like.

While other adhesive families are contemplated as well (e.g., urethanes, acrylics, silanes, or the like), preferably the adhesive is a high temperature epoxy resin, a polyimide, a hybrid polyimide/epoxy resin adhesive or an epoxy novolac/nitrile rubber adhesive. Preferred adhesives are the high temperature epoxy resin adhesives. High temperature epoxy resin adhesive means an adhesive wherein the primary component is an epoxy resin which when cured can withstand exposure to the temperatures mentioned above without decomposing or delaminating from the substrate.

In a particularly preferred embodiment, the adhesive is a mineral filled catalyzed adhesive that includes one or more regular or modified epoxy components, a suitable curing agent and a suitable thixotropic agent for maintaining a room temperature Brookfield viscosity (in uncured state) on the order of about 500 cps.

It should be recognized that the use of the term adhesive herein is not intended to foreclose primers or other bonding agents from the scope of the present invention.

The present invention offers considerable design flexibility. Though mating surfaces can be planar, they need not be. In a preferred embodiment, either or both of the mating surfaces is generally non planar (e.g., contoured, stepped, corrugated, or the like). The employment of molded plastic components also enables the formation of intricately shaped structures. In this regard, the oil pan assembly can have molded or otherwise fabricated in or on one of its surfaces one or more components such as brackets, connectors, cable guides, hose guides, harnesses, clips or the like. Further, conduits, ports or other like passages can be cored or machined into a molded component to enable integration of multiple components into the oil pan assembly.

As will be appreciated by the skilled artisan, among the many advantages of the present invention are that assemblies can be made that are substantially free of folding tangs, a sealing gasket, mechanical fasteners or all of these. However, the scope of the present invention does not foreclose the use of folding tangs, gaskets or fasteners. Indeed, it is contemplated that a gasket might be made from (e.g., by die cutting a gasket) the adhesive or incorporate as a component thereof (e.g. as an impregnant or coating), the adhesive of the present invention. The resulting structure seals much like a gasket would, but also exhibits the desirable mechanical characteristics of the structural adhesive. Additionally, fasteners may be used in conjunction with the adhesive. Preferably, the adhesive will allow fewer or different fasteners than might conventionally be used.

Of particular advantage to the present invention is that the surfaces, structures or both that are joined by the adhesive can be continuous (i.e., do not necessarily require holes for fasteners). The continuity of the surfaces assists in forming joints that are fluid (e.g., air or liquid) tight since the adhesive can be continuous between the surfaces. Referring specifically to FIG. 3, the adhesive can be applied using one of the methods described above to be a continuous shape corresponding to the surfaces or structures.

Though the present invention has been described in the context of automotive vehicle engine oil pans, the use of the invention is not intended to be limited thereby. Any apparatus employing an oil pan subject to operating conditions milder than or comparable to those experienced by an automotive vehicle engine may employ the present technology.

In preparation of the present assembly, the adhesive is applied by contacting the adhesive in a conventional fashion with one or more mating surfaces to form a continuous bead or film. The adhesive may be coated, extruded, brushed or the like onto the surface. The adhesive can be applied immediately before joining components or it can be applied in remote location from the location where the components are bonded together, or the engine. The preferred cure-on-demand adhesive is exposed to conditions such that it will cure and thereby bond the components together and form a seal between them. Such conditions can be applied prior to or after bringing components together for joining. It is well within the average level of skill in the art to determine which operation may be used to cure the adhesive and when it should be performed. In one embodiment the operation may be an operation that is inherent in the assembly or operation of an automotive vehicle.

In another embodiment the assembly may include an outer shell and an inner shell adapted such that the inner shall is located within the outer shell and there is an insulating gap between the two. The gap can be filled with a fluid, or a solid material, such as elastomeric material or foam material. In another embodiment the oil pan assembly may have associated with one of its surfaces a sound attenuating material such as an elastomer or foam.

In another embodiment the assembly of the invention can include a coating or film on the exterior or interior which functions to improve the barrier properties of the oil pan to hydrocarbons. Such a coating of film can reduce the fugitive hydrocarbon emission from an automotive vehicle. Any coating or film which prevents the transmission of hydrocarbons through the assembly may be used. A preferred coating is a carbon-silica based plasma deposited coating as described in U.S. Pat. No. 5,298,587; U.S. Pat. No. 5,320,875; U.S. Pat. No. 5,433,786 and U.S. Pat. No. 5,494,712 incorporated herein by reference.

Other surface treatments might also be employed such as plasma surface treatment pursuant to art disclosed teachings as found in U.S. Pat. No. 5,837,958, incorporated herein by reference.

The assembly of the present invention is capable of withstanding a temperature of about 163° C. (about 325° F.) for at least about 2500, and more preferably about 3000 hours and about 177° C. (about 350° F.) for at least about 75 and more preferably about 100 hours. The assembly exhibits substantially no detectable degradation in the presence of automotive vehicle fluids, such as brake fluid, windshield washer fluid, power steering fluid, engine coolant (standard and lifetime), engine oil (standard, synthetic and sour), gasoline, diesel fuel, ethanol, methanol, starter fluids or the like. The assembly also exhibits no detectable degradation due to exposure to environmentally encountered compounds such as calcium chloride, sodium chloride, exhaust gas (e.g. type) or the like. In a particularly preferred embodiment, the resulting tensile strength of the adhesive of the joint in the assembly is at least about 4000 psi (28 MPa), more preferably at least about 6500 psi (45 MPa), and still more preferably at least about 9000 psi (62 MPa). Further preferably the strength of the joint is greater than the strength of at least one, and preferably more than one, of the individual molded components.

Further preferably the strength of the joint is greater than the strength of at least one, and preferably more than one, of the individual molded components.

The technology of the present oil pan assembly can be employed in combination with other adhesively bonded engine components, such as described in commonly owned co-pending U.S. patent application Ser. No. 09/766,792 (“Adhesively Bonded Valve Cover Cylinder Head Assembly”), and (“Adhesively Bonded Water Conductor Assembly”) (filed contemporaneously herewith), hereby incorporated by reference.

It should be understood that the invention is not limited to the exact embodiment or construction, which has been illustrated and described but that various changes may be made without departing from the spirit and scope of the invention.

What is claimed is:

1. An oil pan assembly, comprising:
a) an engine component having an associated first mating surface;
b) a molded plastic oil pan having an associated second mating surface; and
c) an adhesive in contact with said first mating surface and said second mating surface for joining said first component and said second oil pan to define an oil pan assembly, wherein the resulting joint has a strength greater than the strength of said molded plastic oil pan.

2. The assembly of claim 1, wherein said first mating surface and said second mating surface are generally planar.

3. The assembly of claim 1, wherein said oil pan is a blend of a polyamide and a syndiotactic polystyrene.

4. The assembly of claim 1, wherein said oil pan is an injection molded filled plastic blend of nylon 6,6 and syndiotactic polystyrene.

5. The assembly of claim 1, wherein said joint is substantially free of a sealing gasket.

6. The assembly of claim 1, wherein said joint is substantially free of mechanical fasteners.

7. The assembly of claim 1, wherein a primer contacts said adhesive.

8. The assembly of claim 1, wherein substantially the entirety of the first and second mating surfaces in contact with said adhesive is capable of bonding thereto.

9. An automotive oil pan assembly, comprising:
a) a metal engine having an associated first mating surface;
b) a molded thermoplastic oil pan having an associated second mating surface; and
c) an epoxy adhesive in contact with said first mating surface and said second mating surface for joining said engine block to said oil pan to define an automotive vehicle oil pan assembly.

10. The assembly of claim 9, wherein said first mating surface and said second mating surface are generally planar.

11. The assembly of claim 9, wherein said oil pan is a blend of a polyamide and a syndiotactic polystyrene.

12. The assembly of claim 9, wherein said oil pan is injection molded filled plastic blends of nylon and syndiotactic polystyrene.

13. The assembly of claim 9, wherein said joint is substantially free of a sealing gasket.

14. The assembly of claim 9, wherein said joint is substantially free of mechanical fasteners.

15. The assembly of claim 9, wherein said joint is continuous between said first mating surface and said second mating surface.

16. The assembly of claim 15, wherein a primer contacts said adhesive.

17. The assembly of claim 9, wherein substantially the entirety of the first and second mating surfaces in contact with said adhesive is capable of bonding thereto.
